(19) United States
(12) Patent Application Publication
(10) Pub. No.: US 2025/0193552 A1
(43) Pub. Date: Jun. 12, 2025

(54) IMAGE SENSOR DEVICE AND METHOD OF OPERATION THEREOF

(71) Applicant: UNIST (ULSAN NATIONAL INSTITUTE OF SCIENCE AND TECHNOLOGY), Ulsan (KR)

(72) Inventors: Seong-Jin KIM, Anyang-si (KR); Ki-Eop HONG, Ulsan (KR)

(73) Assignee: UNIST (ULSAN NATIONAL INSTITUTE OF SCIENCE AND TECHNOLOGY), Ulsan (KR)

(21) Appl. No.: 18/787,046

(22) Filed: Jul. 29, 2024

(30) Foreign Application Priority Data
Dec. 12, 2023 (KR) 10-2023-0179554

(51) Int. Cl. H04N 25/773; H04N 25/76; H04N 25/771

(52) U.S. Cl. CPC H04N 25/773; H04N 25/771; H04N 25/7795

(57) ABSTRACT

Disclosed is an image sensor device, which includes a pixel array including a plurality of pixels for detecting an optical signal, and a control circuit that generates count information, inverse count information, and a ramp signal, which are provided to the plurality of pixels, and each of the plurality of pixels determines a time code based on a detection signal detected from the pixel, the ramp signal, and the count information, performs a reset on the pixel based on the time code and the inverse count information, generates sampling data based on the ramp signal and a residual detection signal of the pixel, and outputs the time code and the sampling data.

### CROSS-REFERENCE TO RELATED APPLICATIONS

This application claims priority under 35 U.S.C. § 119 to Korean Patent Application No. 10-2023-0179554 filed on Dec. 12, 2023, in the Korean Intellectual Property Office, the disclosures of which are incorporated by reference herein in their entireties.

### BACKGROUND

Embodiments of the present disclosure described herein relate to an image sensor device, and more particularly, relate to an image sensor device having a wide dynamic range and a method of operating the same.

This research is conducted with support from the Samsung Future Technology Promotion Project (Project Number: SRFC-TA1803-51).

An image sensor may convert an optical signal into an electrical signal. As a computer industry and a communication industry develop, nowadays, there is an increasing demand on a high-performance image sensor in various fields such as a digital camera, a camcorder, a smartphone, a tablet personal computer (PC), a notebook computer, a game console, a security camera, and a medical micro camera.

Conventional image sensors are operated based on analog pixels. Each of the analog pixels outputs analog signals corresponding to optical signals, and the analog signals are converted into digital signals. However, since the analog signals are vulnerable to a noise or coupling in comparison with the digital signals, there is a problem in processing high-resolution image signals.

The ratio between the brightest light and the darkest light that may be extracted at an image level is called a dynamic range. In general, the brightest light that may be extracted is largely determined by a capacitance capacity and a voltage headroom (a magnitude of power supply voltage). A pixel that receives bright light during a given exposure time generates a large number of electrons and should have sufficient capacitance to prevent electron saturation. In addition, the voltage changed by the electrons accumulated in a capacitor is converted by an analog-to-digital converter and is extracted to an image level. However, since the conversion performance of the analog-to-digital converter is limited, to measure a wider range of image levels, the range of voltage converted at the pixel itself should be wide.

### SUMMARY

Embodiments of the present disclosure provide an image sensor with improved dynamic range.

Embodiments of the present disclosure provide an image sensor with improved resolution in a high-illuminance environment.

The problems that are achieved through present disclosure may not be limited to what has been particularly described herein, and other problems not described herein may be more clearly understood from the following detailed description by persons skilled in the art.

According to an embodiment of the present disclosure, an image sensor device includes a pixel array including a plurality of pixels for detecting an optical signal, and a control circuit that generates count information, inverse count information, and a ramp signal, which are provided to the plurality of pixels, and each of the plurality of pixels determines a time code based on a detection signal detected from the pixel, the ramp signal, and the count information, performs a reset on the pixel based on the time code and the inverse count information, generates sampling data based on the ramp signal and a residual detection signal of the pixel, and outputs the time code and the sampling data.

According to an embodiment of the present disclosure, a method of operating an image sensor including a plurality of pixels for detecting an optical signal, includes performing a first mode operation of determining a time code and performing a reset in each of the plurality of pixels, and performing a second mode operation of generating sampling data in each of the plurality of pixels, and the first mode operation includes determining the time code based on a detection signal of the pixel, a ramp signal, and count information, and performing a reset on the pixel based on the time code and inverse count information, and the second mode operation includes generating the sampling data based on the ramp signal and a residual detection signal of the pixel.

According to an embodiment of the present disclosure, an image sensor device includes a pixel array including a plurality of pixels, a ramp generator that generates a ramp signal in response to a ramp control signal, a clock generator that generates a clock signal based on a clock control signal, a counter that generates count information based on a count control signal and the clock signal, an inverse counter that generates inverse count information based on an inverse count control signal and the clock signal, an analog-to-digital converting array that generates a comparison signal by comparing a detection signal output from the pixel array with the ramp signal and generates sampling data based on the comparison signal and the count information, a reset control circuit that generates a time code based on the comparison signal and the count information and generates a reset signal based on the time code, an output buffer that stores the sampling data and the time code and outputs output data including the stored sampling data and the stored time code, and a control circuit that generates the ramp control signal, the clock control signal, the count control signal, and the inverse count control signal.

### BRIEF DESCRIPTION OF THE FIGURES

The above and other objects and features of the present disclosure will become apparent by describing in detail embodiments thereof with reference to the accompanying drawings.

FIGS. 1A and 1B are diagrams for describing an example of determining intensity of light detected by a photo detector of a pixel using a time code.

FIG. 2 is a block diagram illustrating an image sensor device, according to an embodiment of the present disclosure.

FIG. 3 is a diagram illustrating an example of a pixel of FIG. 2.

FIG. 4 is a diagram illustrating an example of a reset control circuit of FIG. 3.

FIG. 5 is a flowchart for describing a first mode operation.

FIG. 6 is a timing diagram for describing a first mode operation.

FIG. 7 is a diagram illustrating an example of an analog-to-digital converter of FIG. 3.

FIG. 8 is a flowchart for describing a second mode operation.

FIG. 9 is a timing diagram for describing a second mode operation.

FIG. 10 is a diagram illustrating an example of outputting output data from a memory circuit in a pixel operation.

FIG. 11 is a diagram illustrating an example of outputting output data in a pixel operation.

FIG. 12 is a diagram illustrating how performance in a high-illuminance environment is improved in a pixel operation, according to an embodiment of the present disclosure.

FIG. 13 is a timing diagram for describing a first mode operation in another embodiment.

FIG. 14 is a diagram for describing an effect in an embodiment of FIG. 13.

FIG. 15 is a block diagram illustrating an image sensor device, according to another embodiment of the present disclosure.

FIG. 16 illustrates an example of a circuit diagram of a pixel group of FIG. 15.

FIG. 17 illustrates another example of a circuit diagram of a pixel group of FIG. 15.

### DETAILED DESCRIPTION

Specific structural or functional descriptions described of embodiments according to the present disclosure disclosed in this specification are exemplified only for the purpose of describing embodiments according to a concept of the present disclosure, and embodiments according to a concept of the present disclosure may be implemented in various forms, and are not limited to the embodiments described in this specification.

Accordingly, while embodiments of the present disclosure are susceptible to various modifications and alternative forms, specific embodiments thereof are illustrated by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure.

Hereinafter, embodiments of the present disclosure may be described in detail and clearly to such an extent that an ordinary one in the art easily implements the present disclosure.

The darkest light that may be extracted from an image sensor is determined by the level of noise generated in the sensor. Noise includes noise caused by a dark current that occurs even when there is no light inside the pixel, reset noise, source-follower thermal noise, and analog-digital converter noise that occurs during a readout process.

Therefore, to have a wide dynamic range, it is necessary to be able to read more electrons while reducing noise. To achieve this, capacitance capacity and power supply voltage should be increased. Capacitance may be increased by increasing the pixel size, but this has the side effect of reducing a spatial resolution and reducing a signal gain of an electron-voltage (Q-V). Additionally, a dynamic range may be improved by increasing the power supply voltage of the pixel. However, to increase the power supply voltage of the pixel, a transistor size is increased.

Unlike voltage-based methods, time-based dynamic range enhancement technology measures the time at which electrons are saturated during exposure time and uses that time information to inversely calculate the light intensity. For example, a counter whose value increases at each integration time operates to generate a time code, and the light intensity may be calculated based on this. The time code may be stored inside the pixel, and then the time code may be read through a readout.

The time-based dynamic range enhancement technology using the time code has an inversely proportional relationship between the light intensity and the time code, so the level of dynamic range improvement is determined by how finely the time axis is divided. However, since the time code is inversely proportional to the light intensity, when the time code divided linearly (at equal intervals) is inversely calculated using the light intensity, the value appears non-linearly (not at equal intervals) according to the time code value. In detail, the quantization level of light reversely calculated using the time code increases as the time code decreases, and the quantization error also increases. This error is called linearization error.

To reduce the linearization error, time codes should be counted very closely. However, as the number of time codes increases, the driving power to deliver the time code to the entire pixel array from a counter outside the pixel array also increases, and since a time code memory exists inside the pixel, there is a limit to the time code increase.

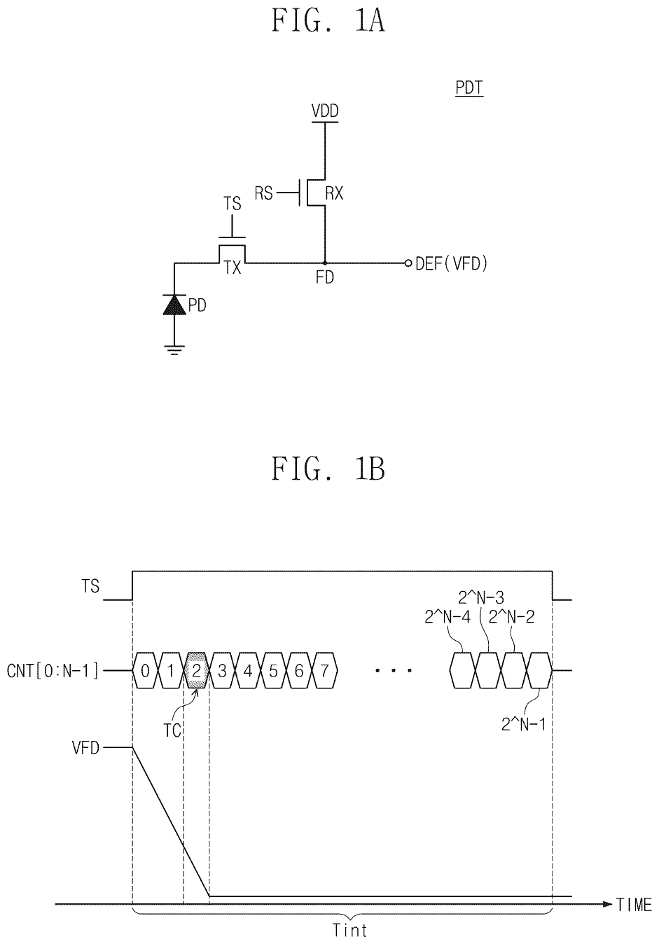

FIGS. 1A and 1B are diagrams for describing an example of determining intensity of light detected by a photo detector of a pixel using a time code.

Referring to FIG. 1A, a photo detector PDT may include a photo diode PD, a transfer transistor TX, and a reset transistor RX. The photo diode PD is connected between a ground node and the transfer transistor TX and may be configured to accumulate photo charges in response to the intensity of light incident from the outside. The transfer transistor TX may be connected between a floating diffusion node FD and the photo diode PD and may operate in response to a transfer signal TS. For example, the transfer transistor TX may be configured to transfer the charges accumulated at the photo diode PD to the floating diffusion node FD in response to the transfer signal TS. The reset transistor RX may be connected between a power supply voltage VDD and the floating diffusion node FD and may operate in response to a reset signal RS. For example, the reset transistor RX may reset a voltage level of the floating diffusion node FD in response to the reset signal RS. Depending on the operation of the photo detector PDT, a voltage (i.e., VFD) of the floating diffusion node FD may change, which may be output as a detection signal DEF.

Referring to FIG. 1B together, a count value of count information CNT may gradually increase during an integration time Tint. The integration time Tint may refer to a period in which the photo diode is exposed to light to generate photoelectrons. The integration time Tint may also refer to a period in which photoelectrons generated by the photo diode PD are accumulated in the floating diffusion node FD.

During the integration time Tint, the transfer signal is enabled so that the transfer transistor may be turned on, and charges accumulated in the photo diode may be transferred to the floating diffusion node FD. Accordingly, the voltage of the floating diffusion node FD, that is, the magnitude of the detection signal DEF, may decrease and finally reach a saturation level.

In this specification, an enable signal means that the signal is at a logic high level, and the transistor to which the enable signal is input to a gate terminal may be turned on.

The count information CNT may be a count value including N bits, and the count value of the count information CNT may gradually increase from 0 to 2\hat{ }N−1 during the integration time Tint.

In one example, the count value at the moment when the voltage of the floating diffusion node FD reaches the saturation level may be stored as a time code TC. The greater the light intensity, the smaller the time code TC may be stored. Based on the stored time code TC, the light intensity may be calculated as in Equation 1 below.

$$LI = \frac{Δ V}{Δ T} \approx \frac{Δ VDD}{Δ TC} \qquad [ Equation 1 ]$$

According to Equation 1, when the time code TC value is sufficiently large, a difference in light intensity calculated at each unit interval of the time code TC may be small. In detail, the linearization error may be sufficiently small. However, as the time code TC becomes smaller, the difference in light intensity calculated at each unit interval of the time code TC may increase. In other words, a problem of increased linearization error may occur.

The present disclosure is intended to solve the above-mentioned problems and provides an image sensor device with improved dynamic range by providing images with high resolution in a high-illuminance environment and a method of operating the same.

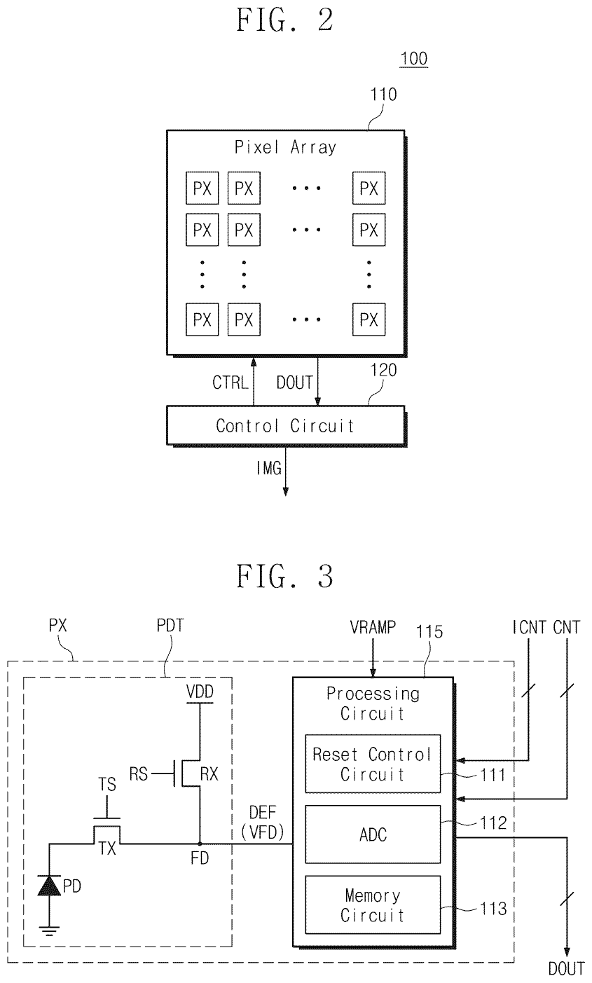

FIG. 2 is a block diagram illustrating an image sensor device, according to an embodiment of the present disclosure.

Referring to FIG. 2, an image sensor device 100 may include a pixel array 110 and a control circuit 120. In an embodiment, the image sensor device 100 may be a camera module included in various electronic devices such as a closed-circuit television (CCTV), a black box, a digital camera, a smartphone, a tablet PC, and a notebook.

The pixel array 110 may include a plurality of pixels PX. Each of the plurality of pixels PX may be configured to detect an optical signal from the outside and output output data DOUT corresponding to the detected optical signal. In an embodiment, each pixel PX may be a digital pixel that outputs a digital signal, and the output data DOUT may be a digital value including a plurality of bits.

The control circuit 120 may output various control signals CTRL for controlling the plurality of pixels PX included in the pixel array 110. For example, the control circuit 120 may be configured to generate a photo detector PDT control signal, a ramp signal, count information, and inverse count information. Based on the control signals CTRL generated from the control circuit 120, each of the plurality of pixels PX may detect the optical signal and may perform a pixel operation.

In an embodiment, the pixel operation may include a first mode operation and a second mode operation. In the first mode operation, each of the plurality of pixels PX may determine the time code TC based on the detection signal DEF and the ramp signal, and may perform a reset based on the determined time code TC. In the second mode operation, each of the plurality of pixels PX may generate sampling data based on counter information, a residual detection signal, and the ramp signal. The output data may include the time code and/or the sampling data.

The control circuit 120 may perform digital signal processing on the output data DOUT received from the pixel array 110. In an embodiment, the control circuit 120 may be configured to output a final image based on the time code and the sampling data received from the pixel array 110.

The control circuit 120 may provide a final image IMG to an external device (e.g., an image signal processor (ISP), an application processor (AP), etc.).

FIG. 3 is a diagram illustrating an example of a pixel of FIG. 2.

Referring to FIG. 3, each pixel PX may include the photo detector PDT and a processing circuit 115. The processing circuit 115 may include a reset control circuit 111, an analog-to-digital converter (ADC) 112, and a memory circuit 113.

The photo detector PDT may be configured to detect an externally sensed optical signal and to convert the detected optical signal into the detection signal DEF. The detection signal DEF may be an analog signal. The photo detector PDT may include the photo diode PD, the transfer transistor TX, and the reset transistor RX, and its operation method may be the same as that described in FIG. 1A.

The reset control circuit 111 may be used to perform the first mode operation during the pixel operation. The reset control circuit 111 may be configured to determine the time code based on the detection signal DEF, the ramp signal, and the count information CNT. The reset control circuit 111 may be configured to perform a reset based on the determined time code and inverse count information ICNT. The reset control circuit 111 may generate an enabled reset signal so as to be output to the photo detector PDT.

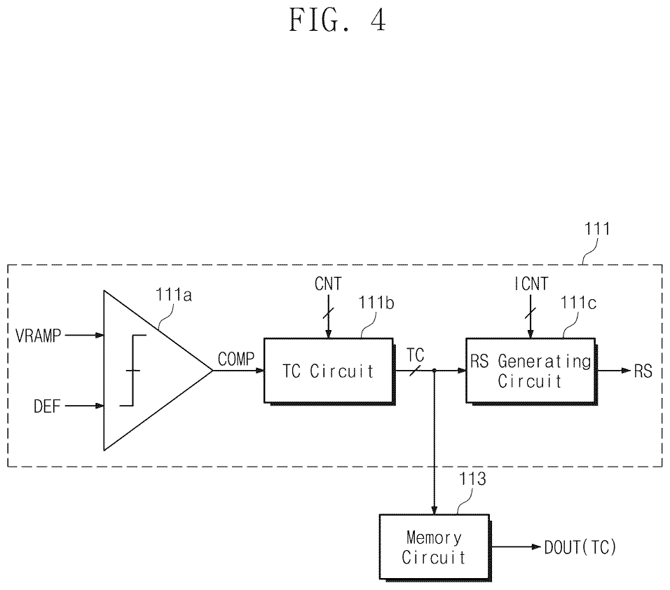

The reset control circuit 111 may be configured to output the time code to the memory circuit 113. The time code may be N bits of digital data (where ‘N’ is a natural number). The detail configuration and operation of the reset control circuit 111 will be described later with reference to FIGS. 4 to 6.

The analog-to-digital converter 112 may be used to perform the second mode operation during the pixel operation. The analog-to-digital converter 112 may be configured to compare the residual detection signal with the ramp signal and to generate the sampling data based on the comparison signal and the count information.

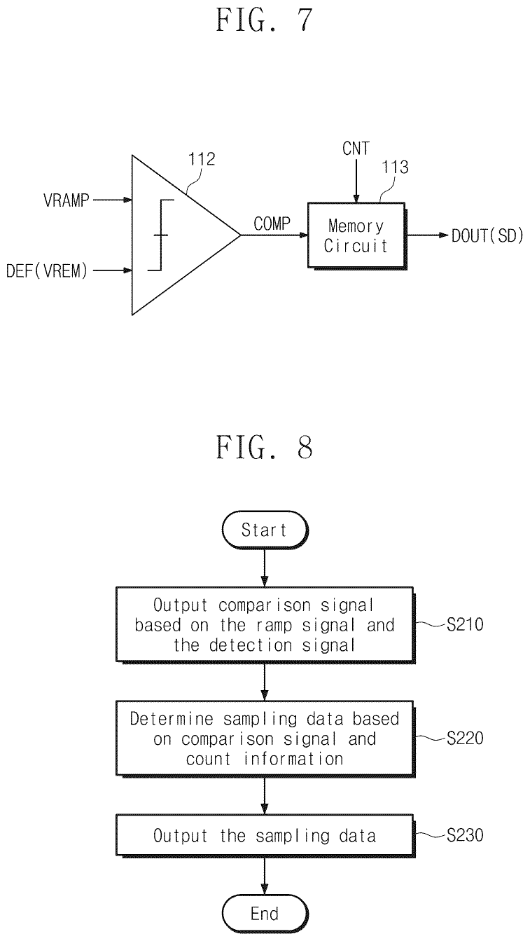

The analog-to-digital converter 112 may be configured to output the sampling data to the memory circuit 113. The sampling data may be M bits of digital data (where ‘M’ is a natural number). The detail configuration and operation of the analog-to-digital converter 112 will be described later with reference to FIGS. 7 to 9.

The memory circuit 113 may be configured to store the time code and/or the sampling data. The memory circuit 113 may temporarily store data composing of a plurality of bits. For example, the memory circuit 113 may be implemented with a latch or a flip-flop, or may be implemented with a volatile memory device such as an SRAM or a DRAM. The memory circuit 113 may be configured to output the time code and/or the sampling data as the output data DOUT.

In an embodiment, the memory circuit 113 may store M bits of data, where ‘M’ may be a number greater than ‘N’. In the first mode operation, the memory circuit 113 may store an N-bit time code and may output the time code TC as the output data DOUT. Thereafter, data stored in the memory circuit 113 may be initialized before performing the second mode operation. In the second mode operation, the memory circuit 113 may store M bits of sampling data and may output the sampling data as the output data DOUT.

In another embodiment, the memory circuit 113 may store M+N bits of data. In the first mode operation, the memory circuit 113 may store N bits of time code, in the second mode operation, the memory circuit 113 may further store M bits of sampling data, and after performing the second mode operation, the memory circuit 113 may output M+N bits of time code and the sampling data as the output data DOUT.

The present disclosure may generate a final image using the time code and the sampling data. Accordingly, in the case of the present disclosure, linearization errors in the image processing process using the time code in a high-illuminance environment may be reduced and the dynamic range may be improved.

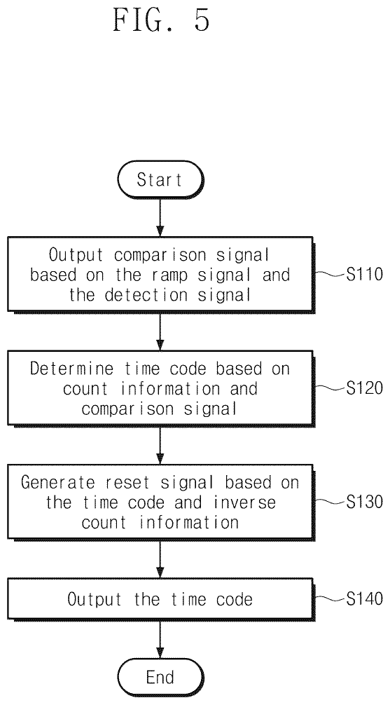

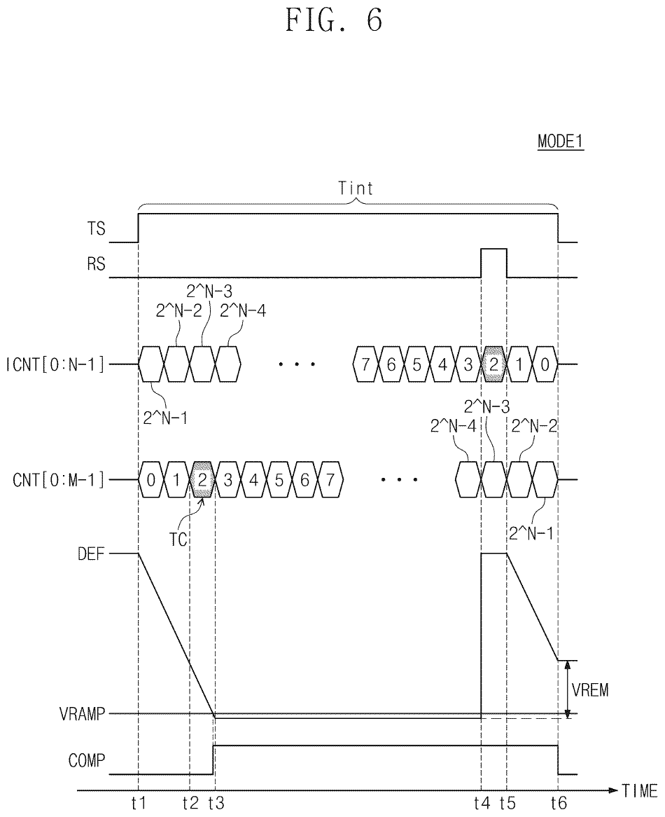

FIG. 4 is a diagram illustrating an example of a reset control circuit of FIG. 3. FIG. 5 is a flowchart for describing a first mode operation. FIG. 6 is a timing diagram for describing a first mode operation. Hereinafter, a method of performing a first mode operation MODE1 using the reset control circuit 111 will be described with reference to FIGS. 4 to 6.

Referring to FIG. 4, the reset control circuit 111 may include a comparator 111a, a TC circuit 111b, and a reset signal generating circuit 111c. The comparator 111a may be configured to generate a comparison signal COMP based on a ramp signal VRAMP and the detection signal DEF. The TC circuit 111b may determine the time code TC based on the comparison signal COMP and the count information CNT. The reset signal generating circuit 111c may generate the enabled reset signal RS based on the time code TC and the inverse count information ICNT.

Referring to FIGS. 5 and 6, in the first mode operation, the transfer signal TS of the photo detector PDT is enabled during the integration time Tint (period from a first time t1 to a sixth time t6), the magnitude of the detection signal DEF may gradually decrease from the initial level to the saturation level, and the level of the ramp signal VRAMP may be maintained uniformly.

In operation S110, the comparator 111a may generate the comparison signal COMP by comparing the ramp signal VRAMP with the detection signal DEF. In the first mode operation MODE1, the magnitude of the ramp signal VRAMP may be less than the magnitude of the power supply voltage VDD (refer to FIG. 3). For example, the magnitude of the ramp signal VRAMP may be set to be close to the saturation level of the pixel PX. For example, the magnitude of the ramp signal VRAMP may be the same as the saturation level of the pixel PX.

When the magnitude of the detection signal DEF is equal to or less than that of the ramp signal VRAMP, the level of the comparison signal COMP may be logic high. When the magnitude of the ramp signal VRAMP is greater than that of the detection signal DEF, the level of the comparison signal COMP may be logic low. The magnitude of the detection signal DEF may gradually decrease, and may become less than the magnitude of the ramp signal VRAMP between the second time t2 and the third time t3, in this case, the level of the comparison signal COMP may change from logic low to logic high.

In operation S120, the TC circuit 111b may determine the time code TC based on the comparison signal COMP and the count information CNT. The count information CNT may be M-bit digital data whose count value gradually increases by ‘1’. At the first time, all M bits of count information may have a value of ‘0’. Among the M bits of count information, N bits may be used to determine the time code (where ‘M’ is a natural number greater than or equal to ‘N’). For example, among count values from 0 to 2\hat{ }M−1, one of the count values from 0 to 2\hat{ }N−1 may be determined as the time code. For example, the count information CNT has a count value from 0 to 2\hat{ }N−1 during the integration time Tint.

In an embodiment, the TC circuit 111b may determine the count value at the moment when the comparison signal COMP changes from logic low to logic high as the time code TC. For example, when the count value is ‘2’ (assuming that ‘N’ is 4) and the comparison signal COMP becomes logic high, the TC circuit 111b may determine the value of ‘2’ as the time code TC, and may output the time code TC to the memory circuit 113. The memory circuit 113 may store the time code TC.

The TC circuit 111b may be implemented with an N-bit counter or an N-bit memory circuit, but is not limited thereto. For example, the TC circuit 111b may not be provided as a separate circuit and may use a storage space in the memory circuit 113.

In operation S130, the reset signal generating circuit 111c may generate the reset signal RS based on the time code TC and the inverse count information ICNT. The inverse count information ICNT may be N-bit digital data whose count value gradually decreases by ‘1’. At the first time, all N bits of inverse count information may have a value of ‘1’. For example, the inverse count information ICNT has a count value from 2\hat{ }N−1 to 0 during the integration time Tint.

The reset signal generating circuit 111c may generate the reset signal RS based on the count value of the inverse count information ICNT and the time code TC.

In an embodiment, the reset signal generating circuit 111c may generate the reset signal RS when the count value of the inverse count information ICNT is the same count value as the time code TC. For example, while the count value of the inverse count information ICNT has the same count value as the time code TC, the enabled reset signal RS may be generated.

For example, the reset signal RS may be enabled from the fourth time t4 to the fifth time t5. Accordingly, the reset transistor RX of the photo detector PDT is turned on, and a reset of the floating diffusion node FD may be performed. As the reset is performed, the magnitude of the detection signal DEF may be initialized from the saturation level to the initial level.

In another embodiment, the reset signal generating circuit 111c may generate the reset signal RS when the count value of the inverse count information ICNT is closer to the time code TC. For example, to secure sufficient time to perform a reset on a pixel, when a difference between the count value of the inverse count information ICNT and the time code TC is within a specific range, the enabled reset signal RS may be generated. Thereafter, when the count value of the inverse count information ICNT becomes less than the time code TC, the reset may be disabled.

At the fifth time t5, the reset signal RS becomes logic low, and the detection signal DEF may gradually decrease again from the initial level.

At the sixth time t6, when the integration time Tint ends, the transfer signal TS becomes logic low and the detection signal DEF may not be saturated. In this specification, the detection signal DEF that is not reached the saturation level when the integration time Tint expires is defined as a residual detection signal VREM.

In the first mode operation, operations S110 to S130 may be performed.

When the first mode operation is completed, in operation S140, the memory circuit 113 may output the time code TC as the output data DOUT to the outside of the pixel PX.

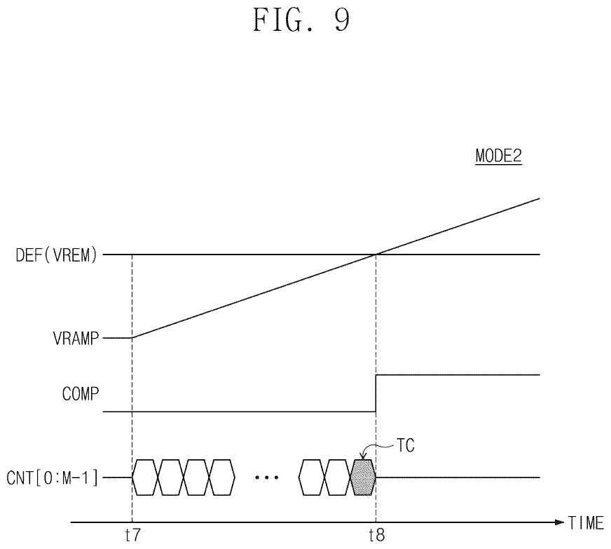

FIG. 7 is a diagram illustrating an example of an analog-to-digital converter of FIG. 3. FIG. 8 is a flowchart for describing a second mode operation. FIG. 9 is a timing diagram for describing a second mode operation. Hereinafter, a method of performing a second mode operation MODE2 using the analog-to-digital converter 112 will be described with reference to FIGS. 7 to 9.

Referring to FIG. 7, the analog-to-digital converter 112 may include the comparator. The comparator may be configured to generate the comparison signal COMP based on the ramp signal VRAMP and the detection signal DEF. The comparator may be provided as a separate circuit, but is not limited thereto, and the comparator 111a in FIG. 4 may be used. The memory circuit 113 may be configured to generate sampling data SD based on the comparison signal COMP and the count information CNT.

Referring to FIGS. 8 and 9, in an embodiment, during the period of the second mode operation MODE2 (period from a seventh time t7 to an eighth time t8), the magnitude of the residual detection signal VREM may be uniform.

In operation S210, the comparator 112 may generate the comparison signal COMP by comparing the ramp signal VRAMP with the residual detection signal VREM. In the second mode operation MODE2, the magnitude of the ramp signal VRAMP may gradually increase from the saturation level.

When the residual detection signal VREM is less than the ramp signal VRAMP, the level of the comparison signal COMP may be logic high. When the ramp signal VRAMP is greater than or equal to the residual detection signal VREM, the comparison signal COMP may have logic low. The magnitude of the ramp signal VRAMP may increase at a uniform slope and then may reach the magnitude of the residual detection signal VREM at the eighth time t8, and when the magnitude of the ramp signal VRAMP starts to become greater than the magnitude of the residual detection signal VREM, the comparison signal COMP may be changed from logic low to logic high.

In operation S220, the memory circuit 113 may determine the sampling data SD based on the count information CNT and the comparison signal COMP. The memory circuit 113 may determine the count information CNT when the comparison signal COMP changes from logic low to logic high as the sampling data SD. The memory circuit 113 may store the determined sampling data SD.

The count information CNT and the sampling data SD may be M-bit digital data. For example, the sampling data SD may have values from 0 to 2\hat{ }M−1.

The memory circuit 113 may be implemented as an M-bit memory circuit, but is not limited thereto.

Operations S210 and S220 may be performed in the second mode operation MODE2.

When the second mode operation MODE2 is completed, in operation S230, the memory circuit 113 may output the sampling data SD as the output data DOUT to the outside of the pixel PX.

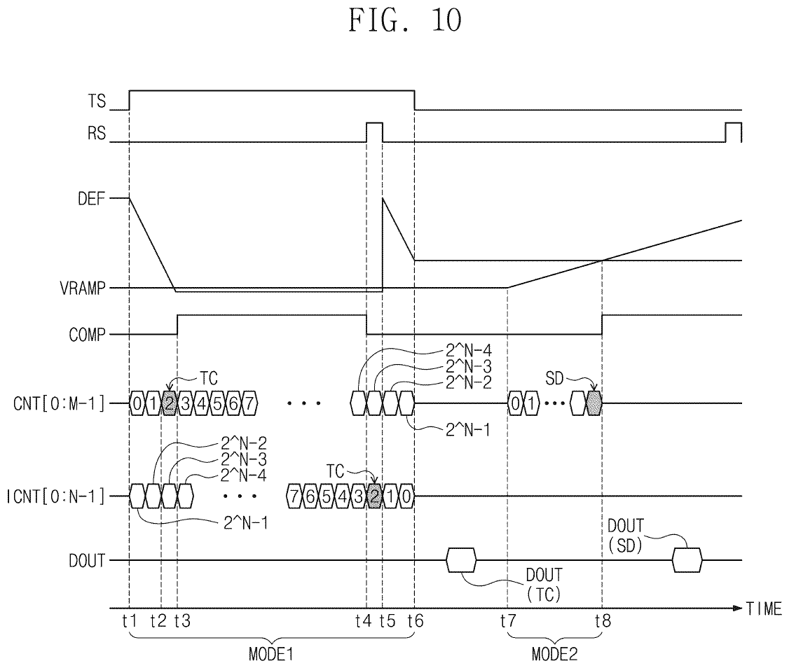

FIG. 10 is a diagram illustrating an example of outputting output data from a memory circuit in a pixel operation.

Referring to FIGS. 6, 9, and 10, the pixel operation may include the first mode operation MODE1 and the second mode operation MODE2. The first mode operation MODE1 may be performed from the first time t1 to the sixth time t6 (during the period including the integration time Tint), and thereafter, the second mode operation MODE2 may be performed from the seventh time t7 to the eighth time t8.

In an embodiment, the memory circuit 113 of FIG. 3 may store the time code TC determined in the first mode operation MODE1, and may output N bits of time code TC as the output data DOUT before the second mode operation MODE2 is performed after the first mode operation MODE1. Thereafter, the memory circuit 113 may initialize data stored before the second mode operation MODE2 is performed such that a space for storing the M-bit sampling data SD is provided. The memory circuit 113 may store the M-bit sampling data SD generated in the second mode operation MODE2, and may output the sampling data SD as the output data DOUT after the second mode operation MODE2 is performed.

In an embodiment, the memory circuit 113 may include at least a space for storing the greater number of N bits or M bits. For example, when M bits are more than N bits, the memory circuit 113 only needs to be able to store at least M bits. The memory circuit 113 may store and output the time code TC in an N-bit storage space among M-bit storage spaces, and then may store and output the sampling data SD in the M-bit storage space after an initialization.

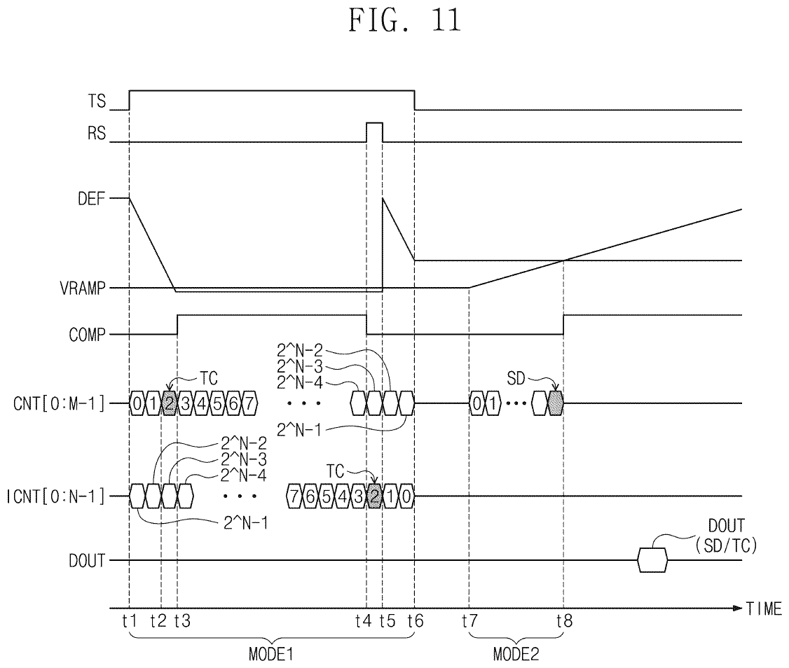

FIG. 11 is a diagram illustrating an example of outputting output data in a pixel operation.

Referring to FIGS. 6, 9, and 11, the pixel operation may include the first mode operation MODE1 and the second mode operation MODE2. The first mode operation MODE1 may be performed from the first time t1 to the sixth time t6 (during the period including the integration time Tint), and thereafter, the second mode operation MODE2 may be performed from the seventh time t7 to the eighth time t8.

In an embodiment, the memory circuit 113 of FIG. 3 may store both the time code TC determined in the first mode operation MODE1 and the M-bit sampling data SD generated in the second mode operation MODE2. The time code TC and the sampling data SD may be output together as the output data DOUT after the second mode operation MODE2 is performed.

The memory circuit 113 may include at least a space for storing both the N bits of time code TC and the M bits of sampling data SD. For example, the memory circuit 113 may include an M+N bits of storage space to store the N bits of time code TC generated in the first mode operation MODE1 and to store the M bits of sampling data SD generated in the second mode operation MODE2 in the remaining space so as to be output simultaneously.

In the case of the embodiment of FIG. 10, the memory circuit 113 requires more storage space than the embodiment of FIG. 11, but the time for performing the pixel operation may be shortened. In the case of the embodiment of FIG. 11, the time for performing the pixel operation increases compared to the embodiment of FIG. 10, but the size of the memory circuit 113 may be reduced.

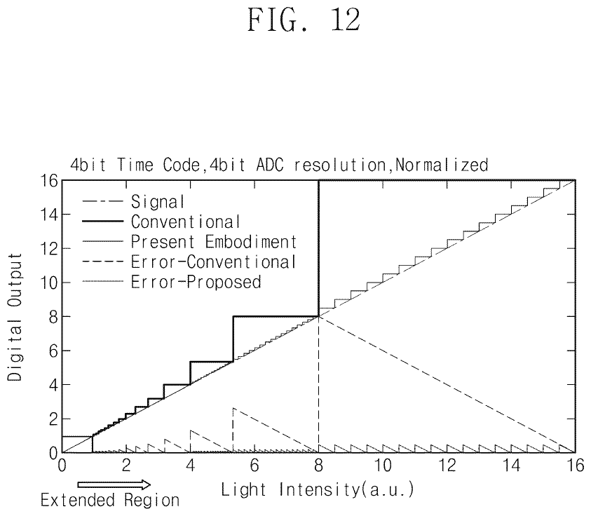

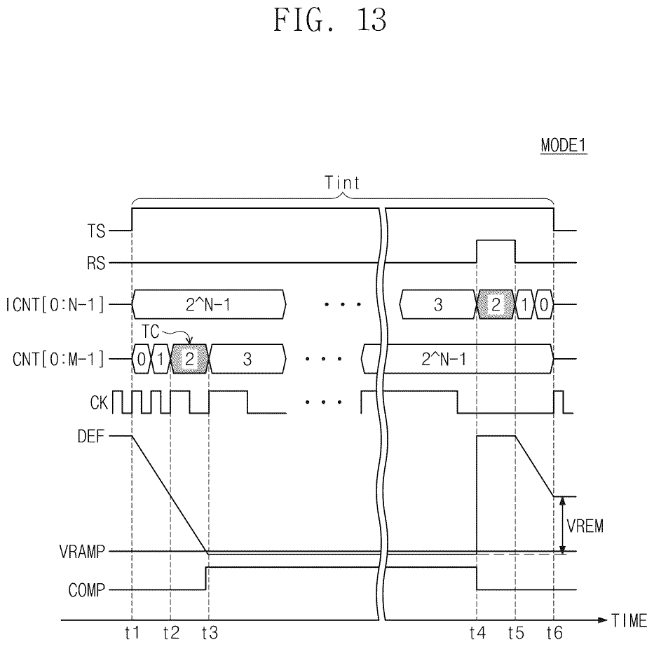

FIG. 12 is a diagram illustrating how performance in a high-illuminance environment is improved in a pixel operation, according to an embodiment of the present disclosure.

Referring to FIG. 12, an X-axis of a graph represents the intensity of detected light, and a Y-axis represents the digital data value of the output data DOUT. It is assumed that the time code TC has 4 bits and the analog-to-digital converter 112 also has 4 bits.

A thin solid line represents the value that the output data DOUT may have when using the time code TC in FIGS. 1A and 1B, and a thin dotted line represents the error between the light intensity and a value of the output data DOUT.

The thick solid line means the value that the output data DOUT may have in the case of the embodiments according to the present disclosure described with reference to FIGS. 2 to 10, and the thick dotted line represents the error between the intensity of light and the value of the output data DOUT.

First, in the example of FIGS. 1A and 1B (the thin solid line and the thin dotted line), when the light intensity is converted to a digital value using only the linear time code TC, it may be seen that the error of the converted output data DOUT increases as the light intensity increases (as the time code TC decreases).

In contrast, in the case of the present disclosure (the thick solid line and the thick dotted line), it may be confirmed that the output data DOUT value is divided by the resolution (number of bits) of the analog-to-digital converter 112 between two consecutive time codes TC. In detail, it may be seen that the linearization error between the intensity of light converted into the output data DOUT and the actual intensity of light is reduced in proportion to the resolution of the analog-to-digital converter 112.

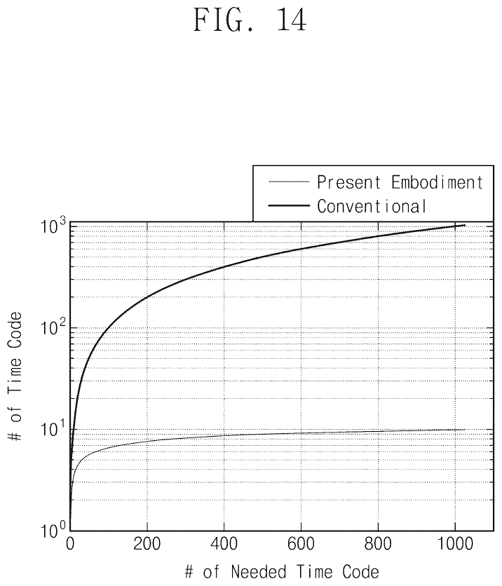

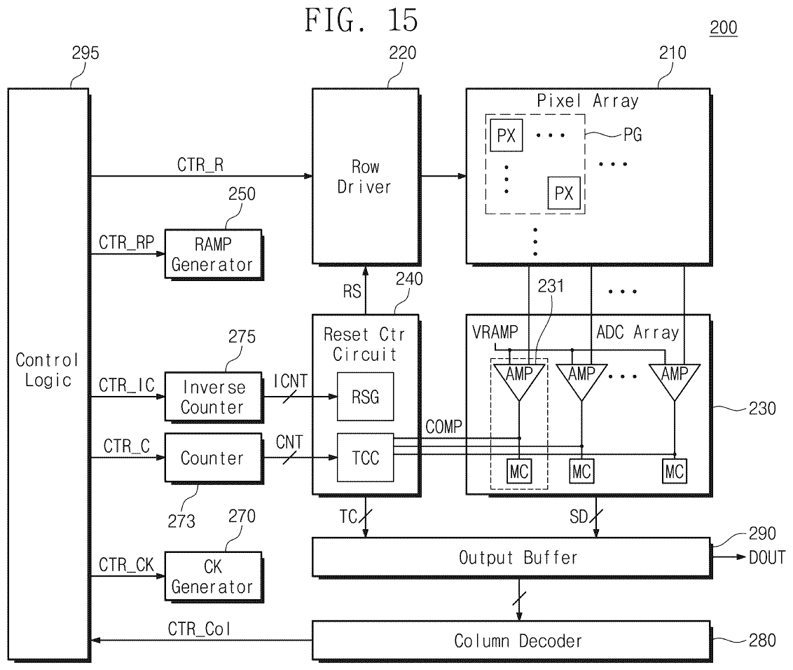

FIG. 13 is a timing diagram for describing a first mode operation in another embodiment. FIG. 14 is a diagram for describing an effect in an embodiment of FIG. 13. Hereinafter, additional descriptions among the content described with reference to FIG. 6 will be omitted to avoid redundancy and differences will be described.

Referring to FIGS. 4 and 13, the transfer signal TS of the photo detector PDT is enabled during the integration time Tint (period from the first time t1 to the sixth time t6), and the magnitude of the detection signal DEF may gradually decrease from the initial level to the saturation level.

The TC circuit 111b may determine the time code TC based on the comparison signal COMP and the count information CNT. The count information CNT may be N-bit digital data whose count value increases based on a clock signal CK.

In an embodiment, the larger the count value of the count information CNT, the longer the period during which the count value increases. For example, in the first mode operation, the period of the clock signal CK may increase in proportion to the exponential power of the count value. Accordingly, the period during which the count value increases may also increase in proportion to the exponential power.

For example, the period of the clock signal CK may be proportional to 2\hat{ }(K−1) (where ‘K’ is a count value having a natural number greater than or equal to ‘1’). For example, when the count value ‘K’ is ‘2’ (‘0010’ for 4 bits), the clock period is twice that when ‘K’ is ‘1’, and when the count value ‘K’ is ‘3’ (‘0011’ for 4 bits), the clock period is 4 times that when ‘K’ is ‘1’.

In an embodiment, as an inverse count value of the inverse count information ICNT decreases, the period during which the inverse count value decreases may become shorter. For example, the period during which the inverse count value decreases may also decrease in proportion to the exponential power.

In the case of the first mode operation MODE1 according to the embodiment of FIG. 13, the time code TC may be reduced during the integration time Tint compared to the first mode operation MODEL of FIG. 6. In detail, the number of bits of the time code TC stored in the memory circuit 113 may be smaller, and while reducing the size of the memory circuit 113, power consumption when performing the pixel operation may be reduced.

Referring to FIG. 14, it may be seen that the number of bits of the time code TC stored and output in the embodiment is reduced in a logarithmic scale compared to the number of bits of the required time code TC.

FIG. 15 is a block diagram illustrating an image sensor device, according to another embodiment of the present disclosure.

Referring to FIG. 15, an image sensor device 200 may convert an optical signal of an object incident through an optical lens into an electrical signal and may convert the converted electrical signal into image data IDTA. For example, the image sensor device 200 may include a pixel array 210 including a plurality of two-dimensionally arranged pixels PX and various electrical circuits for sensing, and the image sensor device 200 may be implemented as a semiconductor chip including a pixel array and a sensing circuit.

The image sensor device 200 may include the pixel array 210, a row driver 220, an analog-to-digital converting array 230 including a plurality of analog-to-digital converters 231, a ramp generator 250, a clock generator 270, a column decoder 280, an output buffer 290, and control logic 295.

The pixel array 210 may convert received optical signals into electrical signals. The pixel array 210 may include a plurality of pixel groups PG arranged in a matrix form, each of which is connected to a plurality of row lines and a plurality of column lines COL. Each pixel group PG may include the plurality of pixels PX.

Each of the plurality of pixels PX may include a photoelectric conversion element. For example, the pixel PX may be implemented with a photoelectric conversion element such as a charge coupled devices (CCD) or a complementary metal oxide semiconductor (CMOS), and may also be implemented with various types of photoelectric conversion elements. For example, the photoelectric conversion element may include a photo diode, a photo transistor, a photo gate, a pinned photodiode, etc. Each of the plurality of pixels PX may include at least one photoelectric conversion element, and the plurality of photoelectric conversion elements may be stacked on each other.

For example, the pixel PX may include the photo diode PD, the transfer transistor TX, the reset transistor RX, a driving transistor DX, and a selection transistor SX. However, the present disclosure is not limited thereto, and the photo diode PD may be replaced with another photoelectric conversion element.

Each of the reset signal RS provided to a gate electrode of the reset transistor RX, the transfer signal TS provided to a gate electrode of the transfer transistor TX, and a selection signal SEL provided to a gate electrode of the selection transistor SX may be provided by the row driver 220, according to a row control signal CTR_R generated by the control logic 295.

The photo diode PD may generate photo charges that vary depending on the intensity of incident light. For example, the photo diode PD may be a P-N junction diode, and may generate charges, that is, electrons with negative charges and holes with positive charges, in proportion to the amount of incident light. The photo diode PD is an example of a photoelectric conversion element and may be at least one of a photo transistor, a photo gate, a pinned photo diode (PPD), and a combination thereof.

The floating diffusion node FD may be formed among the transfer transistor TX, the reset transistor RX, and the driving transistor DX. The transfer transistor TX may transmit photocharges to the floating diffusion node FD in response to the transfer signal TS output from the row driver 220.

The driving transistor DX may amplify the photocharges according to a potential corresponding to the amount of photocharges accumulated in the floating diffusion node FD and may transmit the amplified photocharges to the selection transistor SX. A drain electrode of the selection transistor SX is connected to a source electrode of the driving transistor DX, and the detection signal DEF may be output to the column line COL connected to the pixel PX based on the selection signal SEL output from the row driver 220. The reset transistor RX may reset the floating diffusion node FD to a level of the power supply voltage VDD, based on the reset signal RS provided from the row driver 220.

The plurality of pixels PX may detect light using the photoelectric conversion element and may convert it into the detection signal DEF, which is an electrical signal. The detection signal DEF may include the reset signal RS generated according to a reset operation of each of the plurality of pixels PX, and may include an image signal according to the light detection operation of each of the plurality of pixels PX.

Each of the plurality of pixels PX may detect light in a specific spectral region. For example, the plurality of pixels PX may include the red pixel PX for converting light in a red spectrum region into an electrical signal, the green pixel PX for converting light in a green spectrum region into an electrical signal, and the blue pixel PX for converting light in a blue spectrum region into an electrical signal. A color filter may be disposed on top of each of the plurality of pixels PX to transmit light in a specific spectrum region. As another example, the plurality of pixels PX may include the cyan pixel PX, the yellow pixel PX, the magenta pixel PX, or the white pixel PX.

A micro lens and a color filter may be stacked on top of each of the plurality of pixels PX, and the plurality of color filters of the plurality of pixels PX may form a color filter array. The color filter may transmit light of a specific color, that is, a wavelength of a specific color range, among the light incident through the micro lens. The color that the pixel PX may detect may be determined depending on a color filter provided in the pixel PX. However, it is not limited thereto, and in the embodiment, the photoelectric conversion element provided in the pixel PX may convert light corresponding to the wavelength of the color region into an electrical signal, based on the level of the applied electrical signal, for example, the voltage level. Accordingly, the color that may be detected by the pixel PX may be determined depending on the level of the electrical signal applied to the photoelectric conversion element.

The row driver 220 may drive the pixel array 210 in units of row. The row driver 220 may decode the row control signal CTR_R generated by the control logic 295, and may select at least one row line among the row lines forming the pixel array 210 in response to the decoded row control signal. For example, the row control signal CTR_R may include an address signal or a command indicating address information. In an example embodiment, the row driver 220 may generate a row select signal. The pixel array 210 may output the detection signal DEF from the row selected by the row selection signal provided from the row driver 220 through the column line COL. In detail, the plurality of pixels PX of the pixel array 210 may sequentially output the detection signals DEF in units of row.

The analog-to-digital converting array 230 may convert the detection signal DEF, which is an analog signal input from the pixel array 210, into a digital value. The analog-to-digital converting array 230 may convert the detection signal DEF, which is an analog signal, into the sampling data SD, which is a digital value, based on the ramp signal VRAMP, the clock signal CK, and the detection signal DEF.

The analog-to-digital converting array 230 may include the plurality of analog-to-digital converters 231 arranged in a column direction to process the detection signal DEF provided through the column line COL. Each analog-to-digital converter 231 may include a comparator AMP and a memory circuit MC, the comparator AMP may generate the comparison signal COMP, and the memory circuit MC may determine the sampling data SD so as to be stored. The configuration and operation of each of the comparator AMP and the memory circuit MC may be the same as the analog-to-digital converter 112 described with reference to FIGS. 7 to 9.

In an example embodiment, the analog-to-digital converting array 230 may be referred to as a correlated double sampling circuit. The detection signals DEF output from the plurality of pixels PX may have a deviation due to the unique characteristics of each pixel PX (e.g., a column fixed pattern noise (CFPN), etc.) and/or deviation due to differences in the characteristics of logic for outputting the detection signal DEF from the pixel PX. To compensate for the deviation between these detection signals DEF, obtaining a reset component (or the reset signal RS) and an image component (or an image signal) for each of the detection signals DEF and extracting the difference as a valid signal component is called correlated double sampling.

A reset control circuit 240 may output the time code TC and may enable the reset signal RS, based on the count information CNT provided from a counter 273, the inverse count information ICNT provided from an inverse counter 275, and the comparison signal COMP provided from the analog-to-digital converting array 230.

The reset control circuit 240 may include a plurality of TC circuits TCC and a plurality of reset signal generating circuits RSG, each TC circuit TCC may generate the time code TC, and each reset signal generating circuit RSG may generate the enabled reset signal RS. The TC circuit TCC and the reset signal generating circuit RSG of the reset control circuit 240 may perform the same operations as those described with reference to FIGS. 4 to 6.

The ramp generator 250 may operate based on a ramp control signal CTR_RP provided from the control logic 295. The ramp control signal CTR_RP may include a ramp enable signal. The ramp generator 250 may adjust the magnitude of the ramp signal VRAMP based on the ramp enable signal. For example, when the first mode operation MODE1 is performed, the magnitude of the ramp signal VRAMP may have a uniform magnitude corresponding to the saturation level of the pixel PX. For example, when the second mode operation MODE2 is performed, the magnitude of the ramp signal VRAMP may decrease in a uniform slope.

According to an embodiment, the ramp generator 250 may generate the ramp signal VRAMP having a specific slope, a ramping time, a ramping start voltage level, and/or a ramping end voltage level in response to the ramp control signal CTR_RP. For example, the ramp generator 250 may generate the ramp signal that decreases with a uniform slope, or may generate an reverse ramp signal that increases with a uniform slope.

The clock generator 270 may operate based on a clock control signal CTR_CK provided from the control logic 295. The clock generator 270 may generate the clock signal CK to be provided to the analog-to-digital converting array 230. The generation timing and frequency of the clock signal CK may be controlled by the control logic 295.

The counter 273 may operate based on a count control signal CTR_C and the clock signal CK provided from the control logic 295. The counter 273 may generate the count information CNT that is provided to the reset control circuit 240. The counter 273 may generate the count information CNT whose count value increases based on the clock signal CK. The counter 273 may initialize all bits to ‘0’ based on the count control signal CTR_C.

In an embodiment, during the integration time Tint, the counter 273 may increase the count value of the count information CNT by ‘1’ for each unit period of the clock signal CK.

In another embodiment, during the integration time Tint, the counter 273 may increase the count value of the count information CNT by ‘1’ after a number of clock unit periods proportional to the exponential power of the count value of the count information CNT.

The clock generator 270 may be implemented with a gray code generator. The clock generator 270 may generate a plurality of code values having a resolution according to a set number of bits as a counting clock signal. In this case, the clock generator 270 may function as the counter 273.

The inverse counter 275 may operate based on an inverse count control signal CTR_IC provided from the control logic 295 and the clock signal CK. The inverse counter 275 may generate the inverse count information ICNT provided to the reset control circuit 240. The inverse counter 275 may generate the inverse count information ICNT in which the inverse count value decreases based on the clock signal CK. The inverse counter 275 may initialize all bits to ‘1’ based on the count control signal. For example, the count information CNT may decrease by ‘1’ during the integration time Tint.

The output buffer 290 may temporarily store the sampling data SD output from the analog-to-digital converting array 230 and/or the time code TC output from the reset control circuit 240, then may sense and amplify them so as to be output as the output data DOUT. In detail, the output buffer 290 may perform a function of the memory circuit 113 in FIGS. 2 to 9.

The column decoder 280 may operate based on a column control signal CTR_Col provided from the control logic 295. The column decoder 280 may control the output timing of the pixel PX value stored in the output buffer 290 depending on the column control signal CTR_Col. The column decoder 280 may select a specific column line among the plurality of column lines COL by decoding the column control signal CTR_Col. The column decoder 280 may provide the output data DOUT that corresponds to the selected column line COL and is temporarily stored in a memory of the output buffer 290, to the outside.

The control logic 295 may generally control the image sensor device by generating various control signals. According to an embodiment, the control logic 295 may generate the row control signal CTR_R that controls the row driver 220, the ramp control signal CTR_RP that controls the ramp generator 250, the clock control signal CTR_CK that controls the clock generator 270, the count control signal CTR_C that controls the counter 273, the inverse count control signal CTR_IC that controls the inverse counter 275, and the column control signal CTR_Col that controls the column decoder 280. For example, the control logic 295 may adjust an application time, an application rate, a slope, a start voltage level, and/or a termination voltage level of a bias signal, the ramp signal VRAMP, and the clock signal CK by determining a timing, a level, an amplitude, a duty ratio, and an application time of the row control signal CTR_R, a bias control signal, the ramp control signal CTR_RP, the clock control signal CTR_CK, and/or the column control signal CTR_Col.

The control logic 295 may decode commands provided from the outside and may adjust various control signals to correspond to the commands. According to an embodiment, when a central processing unit (e.g., an application processor) of an electronic device including the image sensor device determines a mode operation of the image sensor device, the control logic 295 may control functional parts of the image sensor device to correspond to the corresponding mode of operation.

The control logic 295 may be implemented as a central processing unit (CPU), an Arithmetic Logic Unit (ALU) that performs arithmetic and logical calculations, bit shifting, etc., a digital signal processor (DSP), a microprocessor, an application specific integrated circuit (ASIC), control logic, etc., but it will be understood that the control logic 295 is not limited thereto. In some embodiments, the control logic 295 may include a state machine composed of a plurality of logic gates, and may include a processor and a memory that stores instructions executed by the processor.

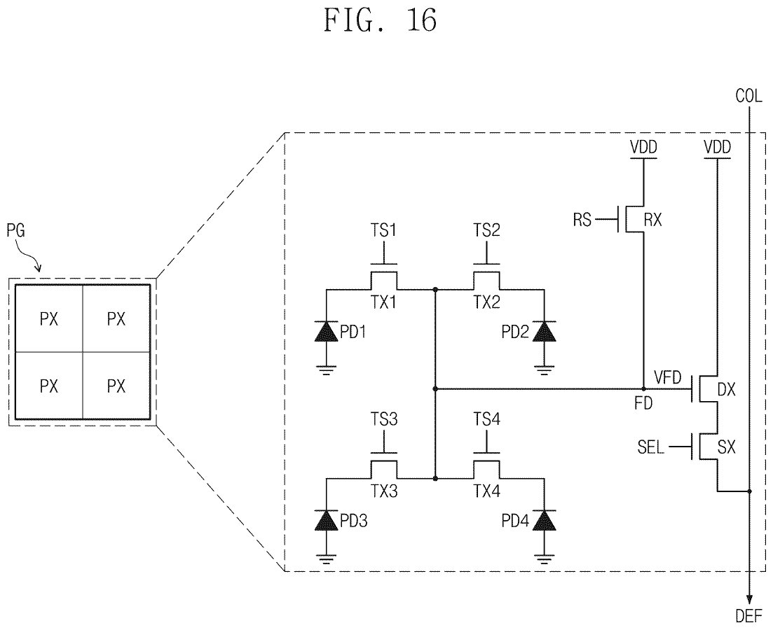

FIG. 16 illustrates an example of a circuit diagram of a pixel group of FIG. 15.

The pixel group PG may include a plurality of pixels. For example, the pixel group PG may include first to fourth pixels. For example, a pixel array may include the pixel group PG arranged in a Tetra Bayer.

The pixel group PG may include photoelectric conversion elements PD1 to PD4, transfer transistors TX1 to TX4, the reset transistor RX, the driving transistor DX, and the selection transistor SX.

A first pixel PX1 may include the first photoelectric conversion element PD1 and the first transfer transistor TX1. A second pixel PX2 may include the second photoelectric conversion element PD2 and the second transfer transistor TX2, and a third pixel PX3 may include the third photoelectric conversion element PD3 and the third transfer transistor TX3. A fourth pixel PX4 may include the fourth photoelectric conversion element PD4 and the fourth transfer transistor TX4. The first to fourth pixels PX1 to PX4 may share the reset transistor RX, the driving transistor DX, and the selection transistor SX.

The transfer transistors TX1 to TX4 may transfer charges generated by the photoelectric conversion elements PD1 to PD4 to the floating diffusion region FD. For example, during the period in which the first transfer transistor TX1 is turned on by a transfer signal TS1 received from the row driver 220, the charges provided from the first photoelectric conversion element PD1 may be accumulated in the floating diffusion region FD. The second to fourth transfer transistors TX2, TX3, and TX4 also operate in a similar manner as described above, so that charges provided from the second to fourth photoelectric conversion elements PD2, PD3, and PD4 may also be accumulated in the floating diffusion region FD. One end of the first to fourth transfer transistors TX1 to TX4 may be respectively connected to the first to fourth photoelectric conversion elements PD1 to PD4, and their other ends may be commonly connected to the floating diffusion region FD.

The floating diffusion region FD may accumulate charges converted by at least one of the first to fourth photoelectric conversion elements PD1 to PD4. The floating diffusion region FD may be connected to a gate terminal of the driving transistor DX, which operates as a source follower amplifier. As a result, a voltage potential corresponding to the charges accumulated in the floating diffusion region FD may be formed.

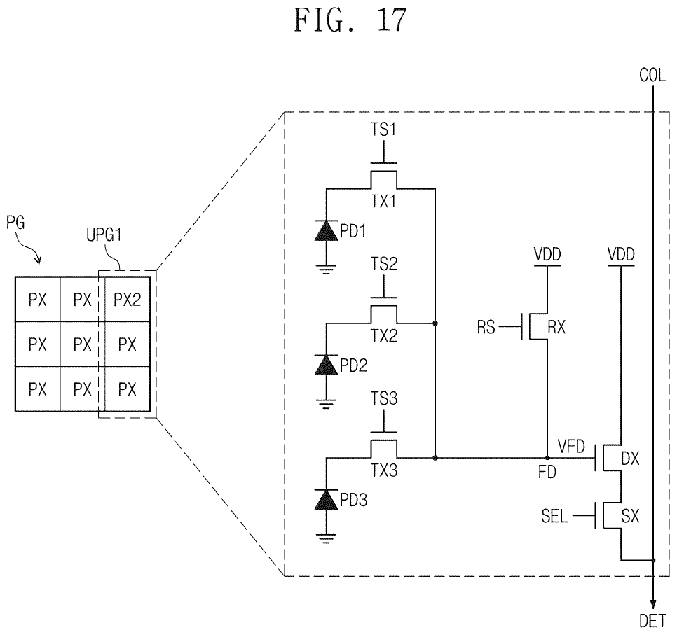

FIG. 17 illustrates another example of a circuit diagram of a pixel group of FIG. 15.

The pixel group PG may include a plurality of unit pixel groups UPG. For example, the pixel group PG may include first to third unit pixel groups UPG. For example, a pixel array may include the pixel group PG arranged in a Nona Bayer. Illustratively, a first unit pixel group UPG1 of the pixel group PG will be described as an example.

The first unit pixel group UPG1 includes the first to third pixels PX1 to PX3. The first unit pixel group UPG1 may include the photoelectric conversion elements PD1 to PD3, the transfer transistors TX1 to TX3, the reset transistor RX, the driving transistor DX, and the selection transistor SX.

The first pixel PX1 may include the first photoelectric conversion element PD1 and the first transfer transistor TX1. The second pixel PX2 may include the second photoelectric conversion element PD2 and the second transfer transistor TX2, and the third pixel PX3 may include the third photoelectric conversion element PD3 and the third transfer transistor TX3. The first to third pixels PX1 to PX3 may share the reset transistor RX, the driving transistor DX, and the selection transistor SX.

The first to third transfer transistors TX1 to TX3 may transfer charges generated by the first to third photoelectric conversion elements PD1 to PD3 to the floating diffusion region FD. For example, during the period in which the first transfer transistor TX1 is turned on by the transfer signal TS1 received from the row driver 220, the charges provided from the first photoelectric conversion element PD1 may be accumulated in the floating diffusion region FD. The second transfer transistor TX2 and the third transfer transistor TX3 also operate in a similar manner as described above, so that charges provided from the photoelectric conversion elements PD2 and PD3 may also be accumulated in the floating diffusion region FD. One end of the first to third transfer transistors TX1 to TX3 may be respectively connected to the first to third photoelectric conversion elements PD1 to PD3, and their other ends may be commonly connected to the floating diffusion region FD.

According to an embodiment of the present disclosure, an image sensor having improved dynamic range is provided.

According to an embodiment of the present disclosure, an image sensor with improved resolution in a high-illuminance environment is provided.

The effects that are achieved through the present disclosure may not be limited to what has been particularly described herein, and other effects not described herein may be more clearly understood from the above detailed description by persons skilled in the art.

The above descriptions are detail embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. Therefore, the scope of the present disclosure should not be limited to the above-described embodiments and should be defined by not only the claims to be described later, but also those equivalent to the claims of the present disclosure.

What is claimed is:

1. An image sensor device comprising:
a pixel array including a plurality of pixels for detecting an optical signal; and
a control circuit configured to generate count information, inverse count information, and a ramp signal, which are provided to the plurality of pixels, and
wherein each of the plurality of pixels is configured to:
determine a time code based on a detection signal detected from the pixel, the ramp signal, and the count information;
perform a reset on the pixel based on the time code and the inverse count information;
generate sampling data based on the ramp signal and a residual detection signal of the pixel; and
output the time code and the sampling data.

2. The image sensor device of claim 1, wherein each of the plurality of pixels includes:
a photo detector configured to detect the optical signal and convert the detected optical signal into the detection signal; and
a processing circuit configured to generate the time code and the sampling data based on the detection signal, the ramp signal, the count information, and the inverse count information.

3. The image sensor device of claim 2, wherein the control circuit is further configured to generate a clock signal, and
wherein the processing circuit includes:
a reset control circuit configured to determine the time code based on the detection signal and the ramp signal and to generate a reset signal based on the time code and the inverse count information;
an analog-to-digital converter configured to generate the sampling data based on the residual detection signal, the ramp signal, and the count information; and
a memory circuit configured to temporarily store the time code and the sampling data.

4. The image sensor device of claim 3, wherein the reset control circuit includes:
a first comparator configured to compare the detection signal with the ramp signal to generate a first comparison signal;
a TC circuit configured to determine the time code based on the first comparison signal and the count information; and
a reset signal generating circuit configured to generate the reset signal based on the time code and the inverse count information.

5. The image sensor device of claim 4, wherein, during an integration time, a count value of the count information gradually increases and a count value of the inverse count information gradually decreases,
wherein the TC circuit determines the count value of the count information as the time code when a level of the first comparison signal changes, and
wherein the reset signal generating circuit generates the reset signal when the count value of the inverse count information reaches the time code.

6. The image sensor device of claim 5, wherein the count value of the count information increases at a uniform period.

7. The image sensor device of claim 5, wherein the count value of the count information has a longer increase period as the count value increases.

8. The image sensor device of claim 4, wherein the analog-to-digital converter includes a second comparator configured to compare the residual detection signal with the ramp signal to generate a second comparison signal, and
wherein the memory circuit is configured to determine the sampling data based on the second comparison signal and the count information.

9. The image sensor device of claim 1, wherein the time code is digital data having N bits, and
wherein the sampling data is digital data having M bits.

10. A method of operating an image sensor including a plurality of pixels for detecting an optical signal, the method comprising:
performing a first mode operation of determining a time code and performing a reset in each of the plurality of pixels; and
performing a second mode operation of generating sampling data in each of the plurality of pixels, and
wherein the first mode operation includes:
determining the time code based on a detection signal of the pixel, a ramp signal, and count information; and
performing the reset on the pixel based on the time code and inverse count information, and
wherein the second mode operation includes generating the sampling data based on the ramp signal and a residual detection signal of the pixel.

11. The method of claim 10, wherein each of the plurality of pixels includes a photo detector and a processing circuit, and
wherein the first mode operation includes:
detecting, by the photo detector, the optical signal and converting the detected optical signal to the detection signal;
determining, by the processing circuit, the time code based on the detection signal, the ramp signal, and the count information; and
performing, by the processing circuit, a reset on the photo detector based on the time code and the inverse count information.

12. The method of claim 11, wherein the determining of the time code includes:
generating, by the processing circuit, a first comparison signal by comparing the detection signal with the ramp signal; and
determining, by the processing circuit, the time code based on the first comparison signal and the count information.

13. The method of claim 12, wherein a magnitude of the ramp signal is maintained uniformly in the first mode operation.

14. The method of claim 12, wherein, during an integration time, a count value of the count information gradually increases and a count value of the inverse count information gradually decreases,
wherein, by the processing circuit, a count value of the count information when a level of the first comparison signal changes is determined as the time code, and
wherein, by the processing circuit, when a count value of the inverse count information reaches the time code, a reset signal is generated.

15. The method of claim 11, wherein the second mode operation includes:
generating, by the processing circuit, a second comparison signal by comparing the residual detection signal and the ramp signal; and
generating, by the processing circuit, the sampling data based on the second comparison signal and the count information.

16. The method of claim 15, wherein a magnitude of the ramp signal increases at a uniform slope in the second mode operation.

17. The method of claim 11, wherein the processing circuit includes a memory circuit, and
further comprising:
storing, by the memory circuit, the time code;
determining, by the memory circuit, the sampling data; and
outputting, by the memory circuit, output data including the stored time code and the determined sampling data.

18. The method of claim 17, wherein the outputting of the output data includes:
outputting the stored time code;
initializing the memory circuit; and
outputting the determined sampling data.

19. An image sensor device comprising:
a pixel array including a plurality of pixels;
a ramp generator configured to generate a ramp signal in response to a ramp control signal;
a clock generator configured to generate a clock signal based on a clock control signal;
a counter configured to generate count information based on a count control signal and the clock signal;
an inverse counter configured to generate inverse count information based on an inverse count control signal and the clock signal;
an analog-to-digital converting array configured to generate a comparison signal by comparing a detection signal output from the pixel array with the ramp signal, and to generate sampling data based on the comparison signal and the count information;
a reset control circuit configured to generate a time code based on the comparison signal and the count information, and to generate a reset signal based on the time code;
an output buffer configured to store the sampling data and the time code and to output output data including the stored sampling data and the stored time code; and
a control circuit configured to generate the ramp control signal, the clock control signal, the count control signal, and the inverse count control signal.

20. The image sensor device of claim 19, wherein each of the plurality of pixels may include a photoelectric conversion element, and
wherein the photoelectric conversion element includes any one of a CCD (Charge Coupled Devices) or a CMOS (Complementary Metal Oxide Semiconductor).
